(19) United States
(12) Patent Application Publication
(10) Pub. No.: US 2026/0167522 A1
(43) Pub. Date: Jun. 18, 2026

(54) RUNOFF POLLUTION LOAD CALCULATION METHOD, APPARATUS, ELECTRONIC DEVICE, AND STORAGE MEDIUM

(71) Applicants: CTG LOGISTICS MANAGEMENT (BEIJING) CO., LTD., Beijing (CN); CHINA THREE GORGES CORPORATION, Wuhan (CN)

(72) Inventors: Yasong CHEN, Beijing (CN); Dianchang WANG, Beijing (CN); Yating ZHU, Beijing (CN); Yunpeng ZHAO, Beijing (CN); Manqi CHANG, Beijing (CN); Zhonglin NIE, Beijing (CN); Fangyuan JING, Beijing (CN); Chong LI, Beijing (CN)

(73) Assignees: CTG LOGISTICS MANAGEMENT (BEIJING) CO., LTD., Beijing (CN); CHINA THREE GORGES CORPORATION, Wuhan (CN)

(21) Appl. No.: 19/534,178

(22) Filed: Feb. 9, 2026

Related U.S. Application Data
(63) Continuation-in-part of application No. PCT/CN2024/116957, filed on Sep. 4, 2024.

(30) Foreign Application Priority Data
Mar. 27, 2024 (CN) 202410355775.4

(51) Int. Cl. C02F 1/00

(52) U.S. Cl. CPC C02F 1/004

(57) ABSTRACT

The present application provides a runoff pollution load calculation method and apparatus, an electronic device, and a storage medium, comprising: determining a target outfall in a target area for a runoff pollution load to be calculated; for any sub-catchment area corresponding to the target outfall, obtaining load characteristic factors corresponding to the current sub-catchment area and characteristic coefficients respectively corresponding to the load characteristic factors; on the basis of the load characteristic factors and the characteristic coefficients, determining a runoff pollution load corresponding to the current sub-catchment area; and determining the sum of runoff pollution loads of the sub-catchment areas corresponding to the target outfall, and correcting the sum of the runoff pollution loads on the basis of a time correction factor between a target year and a preset year, to determine a target runoff pollution load corresponding to the target outfall in the target year.

### CROSS REFERENCE TO RELATED APPLICATIONS

The present application is a continuation-in-part of international application No. PCT/CN2024/116957, filed on Sep. 4, 2024, at international stage, and entitled “RUNOFF POLLUTION LOAD CALCULATION METHOD, APPARATUS, ELECTRONIC DEVICE, AND STORAGE MEDIUM”, which designates the United States and claims the benefit of Chinese patent application No. 2024103557754, filed on Mar. 27, 2024, the entire content of the above application is hereby incorporated by reference into the present application.

### TECHNICAL FIELD

The present application relates to the technical field of urban water environment management, and more particularly, to a runoff pollution load calculation method and apparatus, an electronic device, and a storage medium.

### BACKGROUND ART

As point source pollution in urban areas being effective controlled, an impact of nonpoint source pollution on urban water environments has become increasingly prominent. Rainfall surface runoff pollution, as a significant nonpoint pollution source in urban areas, has characteristics such as uncertain occurrence, and discharge and migration heavily affected by environmental factors, making pollution load calculation thereof relatively complex.

Currently, the primary method for calculating surface runoff pollution load relies on statistical modeling. Specifically, based on analyzing extensive field data, correlations between pollution load and various influencing factors are investigated, and empirical formulas or functional equations are constructed, thereby implementing to load calculations based on actual monitoring data.

However, due to the seasonal and random nature of rainfall in each year, it is difficult to guarantee the timeliness and accuracy of current algorithms in calculating a runoff pollution load.

### SUMMARY OF THE INVENTION

A purpose of the present application is to provide a runoff pollution load calculation method, apparatus, an electronic device, and a storage medium, so as to solve a problem of low accuracy and timeliness in calculating a runoff pollution load in the prior art, and achieve to improve efficiency and accuracy of a runoff pollution load calculation result.

In a first aspect, the present application provides a runoff pollution load calculation method, applied to a runoff water sampling apparatus, wherein the runoff water sampling apparatus comprising a rain gauge, a flow meter, a sampler, a water quality detection device and a data processing device, the data processing device comprises a preset load calculation system, and the method comprises:
determining a target outfall of a runoff pollution load to be calculated within a target region; wherein the rain gauge and the sampler are arranged at the target outfall of the runoff pollution load to be calculated and are connected to the data processing device in a communication way, the sampler comprises a sampling head, and the sampling head comprises an outer protective grid and an inner fine filter mesh, the sampler is connected to the water quality detection device in a piping connection way, the water quality detection device receives wastewater collected by the sampler through a piping for detecting water quality, a water quality detection result comprises pollutant concentrations, after the data processing device receives flow data sent by the flow meter and pollutant concentrations sent by the water quality detection device, the load calculation system calculates the runoff pollution load using the following formula:

$$M = {\int }_{0}^{T} {C}_{t} {Q}_{t} dt = {\sum }_{j = 1}^{n} {C}_{j} {Q}_{j} Δ t$$

wherein M represents a runoff pollution load after a single rainfall; Cₜ represents runoff pollutant concentrations of a rainfall at time t, measured in mg/L; Qₜ represents a runoff instantaneous flow of a rainfall at time t, measured in m³/s; Cⱼ represents runoff pollutant concentrations of a rainfall during a jth sampling, measured in mg/L; Qⱼ represents a runoff instantaneous flow of a rainfall during a jth sampling, measured in m³/s; Δt represents a time interval between two sampling, measured in min;
wherein the target region comprises a plurality of characteristic regions with different regional relevant characteristics, each of the plurality of characteristic regions comprises a plurality of sub-catchment regions, the target region comprises a plurality of outfalls, and each of the plurality of outfalls collects a plurality of runoff pollution loads from different sub-catchment regions;
for any sub-catchment region corresponding to the target outfall, obtaining load characteristic factors corresponding to a current sub-catchment region and characteristic coefficients corresponding to the load characteristic factors when calculating a runoff pollution load based on the load characteristic factors, wherein the load characteristic factors are factors which affect the pollution load formed when runoff pollutants from each of the plurality of sub-catchment regions collects at a catchment outlet, and the characteristic coefficients are determined based on load characteristic factors corresponding to a plurality of preset sub-catchment regions within the target region and a runoff pollution load equivalent in a preset year;
determining a runoff pollution load of the current sub-catchment region in the preset year based on the load characteristic factors and the characteristic coefficients; and
determining a sum of runoff pollution loads for each sub-catchment region corresponding to the target outfall in the preset year, and adjusting the sum of runoff pollution loads based on a time correction factor between a target year and the preset year to determine a target runoff pollution load of the target outfall in the target year.

Based on the aforementioned technical solution, through the reference runoff pollution load equivalent of the pre-selected reference catchment region within the target region in the preset year, the load characteristic factors which affect the pollution load formed when runoff pollutants collect at a catchment outlet of each of the plurality of sub-catchment regions and the corresponding characteristic coefficients thereof are determined, so as to achieve rapid calculation of the runoff pollution load of each catchment region, and rapid calculation of the runoff pollution load of the target outfalls within the target region, thereby solving the technical problems that the calculation results are difficult to meet the timeliness and accuracy requirements for rapid calculation due to large monitoring data volume, repeated monitoring, large random monitoring errors and long load calculation cycles, and achieving to improve efficiency and accuracy of a runoff pollution load calculation result.

In another optional embodiment, before determining a target outfall of a runoff pollution load to be calculated within a target region, the method further comprises:
obtaining data of regional relevant characteristics within the target region that affects runoff pollution loads in different regions, and performing functional region division on the target region based on the data of regional relevant characteristics to obtain a plurality of characteristic regions corresponding to the target region; and
for any characteristic region, performing catchment region division on a current characteristic region based on rainfall catchment ranges to obtain a plurality of sub-catchment regions corresponding to the current characteristic region.

In another optional embodiment, each of the plurality of characteristic regions comprises a reference sub-catchment region and other sub-catchment regions;
correspondingly, the step of determining the characteristic coefficients based on load characteristic factors corresponding to a plurality of preset sub-catchment regions within the target region and a runoff pollution load equivalent in a preset year comprises:
for any characteristic region, determining a reference sub-catchment region within a current characteristic region, obtaining runoff pollution monitoring data of the reference sub-catchment region in the preset year, and determining a reference runoff pollution load equivalent of the reference sub-catchment region in the preset year based on the runoff pollution monitoring data; and
obtaining reference load characteristic factors of a reference sub-catchment regions corresponding to each of the plurality of characteristic regions, and based on each reference load characteristic factor and each reference runoff pollution load equivalent, determining the characteristic coefficients corresponding to the load characteristic factors when calculating runoff pollution load based on the load characteristic factors.

In another optional embodiment, the step of determining a reference runoff pollution load equivalent of the reference sub-catchment region in the preset year based on the runoff pollution monitoring data comprises:
obtaining a predetermined runoff pollution load statistical algorithm, and determining the reference runoff pollution load of the reference sub-catchment region based on the runoff pollution load statistical algorithm and the runoff pollution monitoring data; and
performing unit region runoff pollution load statistical processing on the reference runoff pollution load to determine the reference runoff pollution load equivalent corresponding to the reference sub-catchment region in the preset year.

In another optional embodiment, the step of, based on each reference load characteristic factor and each reference runoff pollution load equivalent, determining the characteristic coefficients corresponding to the load characteristic factors when calculating runoff pollution load based on the load characteristic factors comprises:
for any characteristic region, establishing a load-factor relationship equation between the reference load characteristic factors and the reference runoff pollution load equivalent within the current characteristic region; and
constructing a set of load-factor relational set of equations based on the load-factor relationship equation corresponding to each of the plurality of characteristic regions, and determining the characteristic coefficients based on the set of load-factor relational set of equations and predefined coefficient correlations among each of the characteristic coefficients.

In another optional embodiment, the load characteristic factors comprise road-to-square ratio, building roof ratio, green space ratio, water surface/wetland ratio, and terrain slope factor;
correspondingly, the load-factor relationship equation comprises:

$${S}_{i} = {K}_{pi} \times ( {k}_{1 i} {A}_{i} + {k}_{2 i} {B}_{i} + {k}_{3 i} {C}_{i} + {k}_{4 i} {D}_{i} ) ;$$

wherein, Sᵢ represents the reference runoff pollution load equivalent of the reference sub-catchment region within any characteristic region; Aᵢ represents the road-to-square ratio; Bᵢ denotes the building roof ratio; Cᵢ represents the green space ratio; Dᵢ represents the water surface/wetland ratio; Kₚᵢ represents the terrain slope factor; k₁ᵢ represents a characteristic coefficient corresponding to the road-to-square ratio; k₂ᵢ represents a characteristic coefficient corresponding to the building roof ratio; k3ᵢ represents a characteristic coefficient corresponding to the green space ratio; k₄ᵢ represents a characteristic coefficient corresponding to the water surface/wetland ratio.

In another optional embodiment, the coefficient correlations comprises: equal characteristic coefficients corresponding to the building roof ratios in different characteristic regions, equal characteristic coefficients corresponding to the water surface/wetland ratios in different characteristic regions, and a predetermined proportional relationship between the characteristic coefficients corresponding to the green space ratio and the characteristic coefficients corresponding to the road-to-square ratios in the same characteristic region.

In a second aspect, the present application provides a runoff pollution load calculation apparatus, applied to a runoff water sampling apparatus, wherein the runoff water sampling apparatus comprising a rain gauge, a flow meter, a sampler, a water quality detection device and a data processing device, the data processing device comprises a preset load calculation system, and the apparatus comprises:
a target outfall determining module, configured to determine a target outfall of a runoff pollution load to be calculated within a target region; wherein the rain gauge and the sampler are arranged at the target outfall of the runoff pollution load to be calculated and are connected to the data processing device in a communication way, the sampler comprises a sampling head, and the sampling head comprises an outer protective grid and an inner fine filter mesh, the sampler is connected to the water quality detection device in a piping connection way, the water quality detection device receives wastewater collected by the sampler through a piping for detecting water quality, a water quality detection result comprises pollutant concentrations, after the data processing device receives flow data sent by the flow meter and pollutant concentrations sent by the water quality detection device, the load calculation system calculates the runoff pollution load using the following formula:

$$M = {\int }_{0}^{T} {C}_{t} {Q}_{t} dt = {\sum }_{j = 1}^{n} {C}_{j} {Q}_{j} Δ t$$

wherein M represents a runoff pollution load after a single rainfall; Cₜ represents runoff pollutant concentrations of a rainfall at time t, measured in mg/L; Qₜ represents a runoff instantaneous flow of a rainfall at time t, measured in m³/s; Cⱼ represents runoff pollutant concentrations of a rainfall during a jth sampling, measured in mg/L; Qⱼ represents a runoff instantaneous flow of a rainfall during a jth sampling, measured in m³/s; Δt represents a time interval between two sampling, measured in min;
wherein the target region comprises a plurality of characteristic regions with different regional relevant characteristics, each of the plurality of characteristic regions comprises a plurality of sub-catchment regions, the target region comprises a plurality of outfalls, and each of the plurality of outfalls collects a plurality of runoff pollution loads from different sub-catchment regions;
a data obtaining module, configured to, for any sub-catchment region corresponding to the target outfall, obtain load characteristic factors corresponding to a current sub-catchment region and characteristic coefficients corresponding to the load characteristic factors when calculating a runoff pollution load based on the load characteristic factors, wherein the load characteristic factors are factors which affect the pollution load formed when runoff pollutants from each of the plurality of sub-catchment regions collects at a catchment outlet, and the characteristic coefficients are determined based on load characteristic factors corresponding to a plurality of preset sub-catchment regions within the target region and a runoff pollution load equivalent in a preset year;
a runoff pollution load determining module, configured to determine a runoff pollution load of the current sub-catchment region in the preset year based on the load characteristic factors and the characteristic coefficients; and
a target runoff pollution load determining module, configured to determine a sum of runoff pollution loads for each sub-catchment region corresponding to the target outfall in the preset year, and adjust the sum of runoff pollution loads based on a time correction factor between a target year and the preset year to determine a target runoff pollution load of the target outfall in the target year.

In another optional embodiment, the apparatus further includes:
a characteristic region determining unit, configured to, before determining a target outfall of a runoff pollution load to be calculated within a target region, obtain data of regional relevant characteristics within the target region that affects runoff pollution loads in different regions, and perform functional region division on the target region based on the data of regional relevant characteristics to obtain a plurality of characteristic regions corresponding to the target region; and
a sub-catchment region determining unit, configured to, for any characteristic region, perform catchment region division on a current characteristic region based on rainfall catchment ranges to obtain a plurality of sub-catchment regions corresponding to the current characteristic region.

In another optional embodiment, each of the plurality of characteristic regions comprises a reference sub-catchment region and other sub-catchment regions;
correspondingly, the data obtaining module including:
a reference runoff pollution load equivalent determining sub-module, configured to, for any characteristic region, determine a reference sub-catchment region within a current characteristic region, obtain runoff pollution monitoring data of the reference sub-catchment region in the preset year, and determine a reference runoff pollution load equivalent of the reference sub-catchment region in the preset year based on the runoff pollution monitoring data; and
a characteristic coefficient determining sub-module, configured to obtain reference load characteristic factors of a reference sub-catchment regions corresponding to each of the plurality of characteristic regions, and based on each reference load characteristic factor and each reference runoff pollution load equivalent, determine the characteristic coefficients corresponding to the load characteristic factors when calculating runoff pollution load based on the load characteristic factors.

In another optional embodiment, the reference runoff pollution load equivalent determining sub-module includes:
a reference runoff pollution load equivalent determining unit, configured to obtain a predetermined runoff pollution load statistical algorithm, and determine the reference runoff pollution load of the reference sub-catchment region based on the runoff pollution load statistical algorithm and the runoff pollution monitoring data; and perform unit region runoff pollution load statistical processing on the reference runoff pollution load to determine the reference runoff pollution load equivalent corresponding to the reference sub-catchment region in the preset year.

In another optional embodiment, the characteristic coefficient determining sub-module includes:
a load-factor relationship equation determining unit, configured to, for any characteristic region, establish a load-factor relationship equation between the reference load characteristic factors and the reference runoff pollution load equivalent within the current characteristic region; and
a characteristic coefficient determining unit, configured to construct a set of load-factor relational set of equations based on the load-factor relationship equation corresponding to each of the plurality of characteristic regions, and determine the characteristic coefficients based on the set of load-factor relational set of equations and predefined coefficient correlations among each of the characteristic coefficients.

In another optional embodiment, the load characteristic factors comprise road-to-square ratio, building roof ratio, green space ratio, water surface/wetland ratio, and terrain slope factor;
correspondingly, the load-factor relationship equation comprises:

$${S}_{i} = {K}_{pi} \times ( {k}_{1 i} {A}_{i} + {k}_{2 i} {B}_{i} + {k}_{3 i} {C}_{i} + {k}_{4 i} {D}_{i} ) ;$$

wherein, Sᵢ represents the reference runoff pollution load equivalent of the reference sub-catchment region within any characteristic region; Aᵢ represents the road-to-square ratio; Bᵢ denotes the building roof ratio; Cᵢ represents the green space ratio; Dᵢ represents the water surface/wetland ratio; Kₚᵢ represents the terrain slope factor; k₁ᵢ represents a characteristic coefficient corresponding to the road-to-square ratio; k₂ᵢ represents a characteristic coefficient corresponding to the building roof ratio; k3ᵢ represents a characteristic coefficient corresponding to the green space ratio; k₄ᵢ represents a characteristic coefficient corresponding to the water surface/wetland ratio.

In another optional embodiment, the coefficient correlations comprises: equal characteristic coefficients corresponding to the building roof ratios in different characteristic regions, equal characteristic coefficients corresponding to the water surface/wetland ratios in different characteristic regions, and a predetermined proportional relationship between the characteristic coefficients corresponding to the green space ratio and the characteristic coefficients corresponding to the road-to-square ratios in the same characteristic region.

In a third aspect, the present application provides a terminal electronic device, wherein, the terminal electronic device comprises: a processor and a memory connected to the processor in a communication way;
the memory has computer executable instructions stored thereon; and
the processor is configured to, when executing the computer executable instructions, implement the runoff pollution load calculation method according to the first aspect.

In a fourth aspect, the present application provides a computer-readable storage medium, wherein the computer-readable storage medium has computer-executable instructions stored thereon, and the computer-executable instructions, when executed by the processor, are configured to implement the method according to the first aspect.

In a fifth aspect, the present application provides a computer program product, including a computer program, when executed by the processor, is configured to implement the method according to the first aspect.

In the solutions provided by the present application, through the reference runoff pollution load equivalent of the pre-selected reference sub-catchment region within the target region in the preset year, the load characteristic factors which affect the pollution load formed when runoff pollutants from each of the plurality of sub-catchment regions collect at a catchment outlet and the corresponding characteristic coefficients thereof are determined, so as to achieve rapid calculation of the runoff pollution load of each catchment region, and rapid calculation of the runoff pollution load of the target outfalls within the target region, thereby solving the technical problems that the calculation results are difficult to meet the timeliness and accuracy requirements for rapid calculation due to large monitoring data volume, repeated monitoring, large random monitoring errors and long load calculation cycles, and achieving to improve efficiency and accuracy of a runoff pollution load calculation result.

### BRIEF DESCRIPTION OF THE DRAWINGS

The drawings herein are incorporated into the specification and form part of the specification. They illustrate embodiments of the present application and, together with the specification, are used to explain principles of the present application.

FIG. 1 is a structural diagram of a of a runoff water sampling apparatus provided by an embodiment of the present application;

FIG. 2 is a partially enlarged schematic diagram of the sampler provided by an embodiment of the present application;

FIG. 3 illustrates an application scenario diagram of a runoff pollution load calculation method provided by the present application;

FIG. 4 illustrates a flowchart diagram of a runoff pollution load calculation method provided by an embodiment of the present application;

FIG. 5 illustrates a structural diagram of a runoff pollution load calculation apparatus provided by an embodiment of the present application;

FIG. 6 illustrates a structural diagram of an electronic device provided by an embodiment of the present application; and

FIG. 7 illustrates a block diagram of a terminal electronic device provided by an embodiment of the present application.

Through the above-mentioned drawings, clear embodiments of the present application are shown, which will be described in greater detail hereinafter. Neither these drawings nor the written descriptions are intended to limit an idea scope of the present application in any manner; instead, they are provided to illustrate the concepts of the present application to those skilled in the art by reference to specific embodiments.

### DETAILED DESCRIPTION OF THE EMBODIMENTS

Detailed descriptions will be given herein of exemplary embodiments, examples of which are shown in the drawings. Where the following description refers to the drawings, the same numerals in different drawings represent the same or similar elements unless otherwise indicated. The examples described in the following exemplary embodiments do not represent all examples identical with the present application. Instead, they are merely examples of apparatuses and methods identical with some aspects of the present application as described in detail in the appended claims.

In the prior art, when calculating a runoff pollution load, correlations between pollution load and various influencing factors are investigated, and empirical formulas or functional equations are constructed, and then a runoff pollution load is determined. For example, the pollution load equivalent method is used to calculate the runoff pollution load. However, the aforesaid methods rely on a large volume of actual monitoring data. To obtain a pollutant weighted average concentration that can relatively accurately represent the runoff pollution status, it is necessary to conduct actual measurements of rainfall-runoff for at least 15 to 20 rainfall events in the sub-catchment areas included in the target outfall, and then calculate the runoff pollution load of the target outfall. It gives rise to problems such as a large amount of monitoring data, repeated monitoring, large random monitoring errors and a long load calculation cycle, which in turn leads to the technical problems that the calculation results fail to meet the timeliness requirement for rapid calculation and the accuracy requirement.

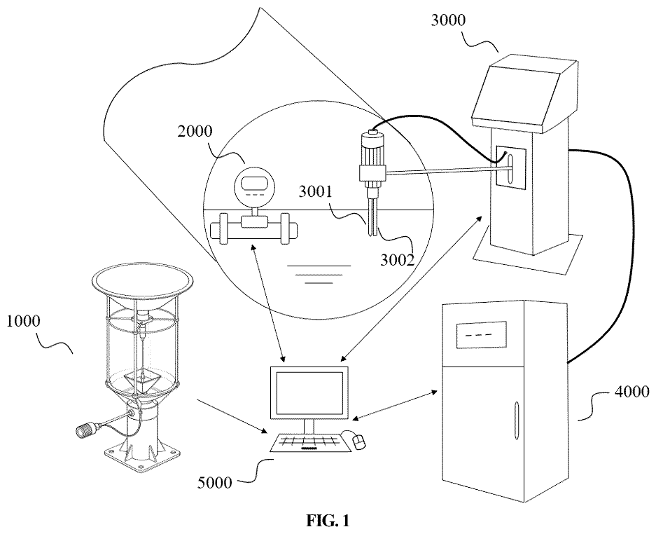

FIG. 1 is a structural diagram of a runoff water sampling apparatus provided by an embodiment of the present application. As shown in FIG. 1, the runoff water sampling apparatus 1 consists of a rain gauge 1000, a flow meter 2000, a sampler 3000, a quality detection device 4000, and a data processing device 5000. During rainfall, the rain gauge 1000 is used to measure rainfall volume. Types of The rain gauge 1000 used in the embodiments of the present application is not limited, which may be a tipping-bucket type, a siphon type, or graduated cylinder type. As shown in FIG. 1, the rain gauge 1000 is a tipping-bucket type. When a weight of collected rainwater in the tipping bucket reaches a calibrated value, the center of gravity of the tipping bucket will shift and the tipping bucket will automatically tip over under the action of gravity. When the tipping bucket tips over, it will drive a reed switch beside it, and an electrical pulse signal is output or each tipping action. After tipping over, the empty tipping bucket will rotate to the upper position and continue to receive rainwater, and the above process is repeated in a cycle. Each electrical pulse signal corresponds to a fixed rainfall value, and the cumulative rainfall can be converted by multiplying a quality of pulses by a single-pulse rainfall value. A communication connection is adopted between the rain gauge 1000 and the data processing device 5000, enabling the rain gauge 1000 to transmit collected rainfall data to the data processing device 5000. After the data processing device 5000 receives the rainfall volume counted by the rain gauge 1000, it can initiate an actual measurement if it determines that the rainfall volume meets the above-mentioned actual measurement conditions for rainfall runoff.

First, at the start of the actual measurement, the flow meter 2000 and the sampler 3000 are arranged at the target outfall of the runoff pollution load to be calculated. The flow meter 2000 and the data processing device 5000 are connected in a communication way. That is, once the conditions for starting the actual measurement are met, the data processing device 5000 sends a start command in a form of an electrical signal to the flow meter 2000. The flow meter 2000 is used to detect a flow through the target outfall. Types of flowmeter 2000 used In the embodiments of the present application is not limited, such as electromagnetic flow meters, ultrasonic flow meters, etc. As shown in FIG. 1, the flow meter 2000 is an electromagnetic flow meter, which is suitable for measuring discharge flow of the outfall containing contaminated media such as sediment and sewage. When energized, the electromagnetic coil (not shown) within the electromagnetic flow meter generates a uniform magnetic field, rendering water conductive. As the conductive water flow cuts through the magnetic field lines at velocity v, an induced electromotive force E is generated at electrodes on both sides of the measuring tube. The magnitude of the electromotive force is proportional to the water flow velocity, magnetic field strength, and the inner diameter of the measuring tube (E=k*B*D*v, wherein k is a constant, B is the magnetic field strength, and D is an inner diameter of the measuring tube). The flow meter 2000 then converts the measured electromotive force E data into water flow velocity. Combined with a cross-sectional area of the measuring tube, instantaneous flow value is calculated. Cumulative data yields total outfall flow value, which is transmitted to the data processing device 5000.

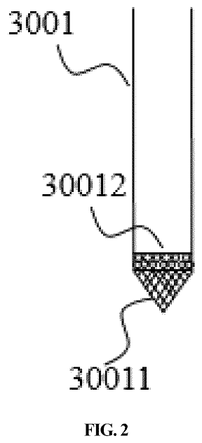

The sampler 3000, also arranged at the target outfall, is connected to the data processing device 5000 in a communication way. Specifically, once the conditions for initiating actual measurement are met, the data processing device 5000 transmits a start command as an electrical signal to the sampler 3000. The sampler 3000 also includes a sensor 3002. When detecting water level changes-such as a drop in water level- and the sampler 3000 is positioned too far from the water surface to sample, the sensor 3002 transmits a signal to the data processing device 5000. Subsequently, the data processing device 5000 sends a descent command to the sampler 3000, lowering it to an appropriate height to complete sampling. FIG. 2 is a partially enlarged schematic diagram of the sampler 3000. As shown in FIG. 2, the sampler 3000 includes a sampling head 3001, which is immersed into wastewater discharged through the target outfall for sampling extraction. The sampling head 3001 further includes an outer protective grid 30011 and an inner fine filter mesh 30012. The outer protective grid 30011 effectively intercepts large particulate matter such as leaves and gravel, preventing damage to the inner fine filter mesh 30012 from impurities in the water flow. The inner fine mesh filter 30012 further filters out fine sand, ensuring a sampling channel remains unobstructed.

The sampler 3000 is connected to the water quality detection device 4000 in a piping connection way. Water collected from the target outfall by the sampler 3000 is conveyed through a piping to the water quality detection device 4000. The water quality detection device 4000 initiates detection upon receiving instructions from the data processing device 5000. The water quality detection device 4000 has a replaceable analytical unit design, allowing flexible configuration of core pollutant index detection modules based on monitoring requirements to cover key runoff pollution parameters. Based on flow characteristics of different target outfalls and pollution characteristics of distinct sub-catchment regions, core pollution indexes, such as Chemical Oxygen Demand (COD), Suspended Solids (SS), Ammonia Nitrogen (NH₃—N), and Total Phosphorus (TP), are precisely detected. Detection methods include gravimetric analysis (GB/T 11901-1989) and the potassium dichromate method, ensuring data authority and comparability. The water quality monitoring device 4000 effectively captures water quality fluctuation patterns across different sub-catchment regions and rainfall events, providing precise data foundations for subsequent pollution load accounts. The water quality monitoring device 4000 is connected to the data processing device 5000 in a communication way, and transmit the detected pollutant concentrations to the data processing device 5000.

The data processing device 5000 is a computer device comprising a pre-installed load calculation system. Upon receiving flow data sent by the flow meter 2000 and pollutant concentrations sent by the water quality detection device 4000, the load calculation system calculates the runoff pollution load using the following formula:

$$M = {\int }_{0}^{T} {C}_{t} {Q}_{t} dt = {\sum }_{j = 1}^{n} {C}_{j} {Q}_{j} Δ t$$

wherein M represents a runoff pollution load after a single rainfall; Cₜ represents runoff pollutant concentrations of a rainfall at time t, measured in mg/L; Qₜ represents a runoff instantaneous flow of a rainfall at time t, measured in m³/s; Cⱼ represents runoff pollutant concentrations of a rainfall during a jth sampling, measured in mg/L; Qⱼ represents a runoff instantaneous flow of a rainfall during a jth sampling, measured in m³/s; Δt represents a time interval between two sampling, measured in min.

The runoff pollution load calculation method provided by the present application aims to solve the aforementioned technical problems in the prior art. Specifically, through the reference runoff pollution load equivalent of the pre-selected reference catchment region within the target region in the preset year, the load characteristic factors which affect the pollution load formed when runoff pollutants collect at a catchment outlet of each of the plurality of sub-catchment regions and the corresponding characteristic coefficients thereof are determined, so as to achieve rapid calculation of the runoff pollution load of each catchment region, and rapid calculation of the runoff pollution load of the target outfalls within the target region, thereby solving the technical problems that the calculation results are difficult to meet the timeliness and accuracy requirements for rapid calculation due to large monitoring data volume, repeated monitoring, large random monitoring errors and long load calculation cycles, and achieving to improve efficiency and accuracy of a runoff pollution load calculation result.

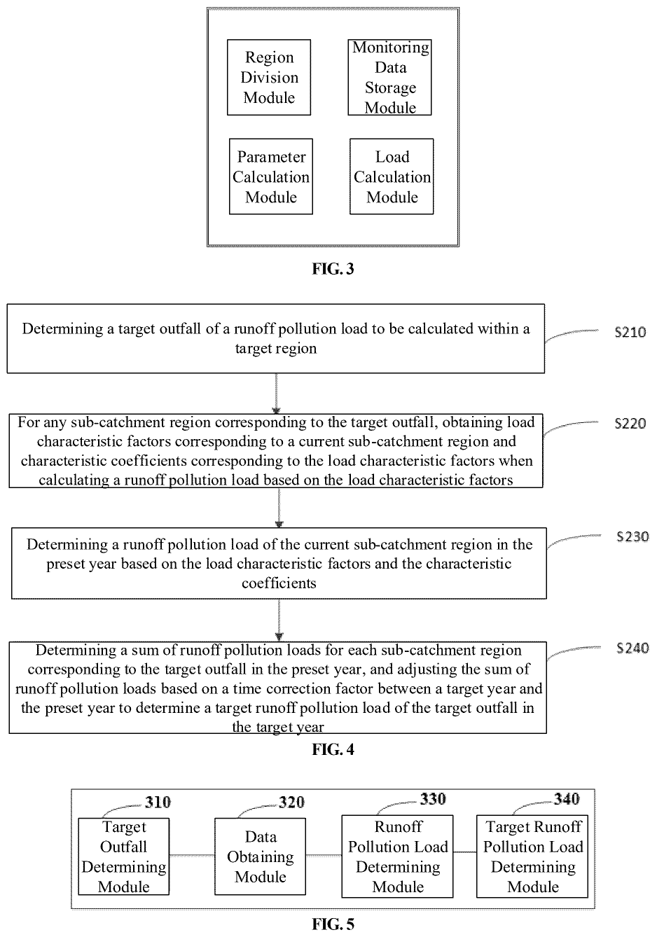

FIG. 3 illustrates an application scenario diagram of a runoff pollution load calculation method provided by the present application. For ease of understanding, the application scenarios applied to the embodiments of the present application are described below with reference to FIG. 1. As shown in FIG. 3, the aforementioned runoff pollution load calculation method can be applied within a pre-installed load calculation system. The system may include a region division module, a monitoring data storage module, a parameter calculation module, and a load calculation module. The region division module is configured to perform multi-level region division on the target region, determine characteristic regions contained within the target region, wherein each characteristic region includes a reference sub-catchment region and other sub-catchment regions, and determine sub-catchment regions corresponding to the target outfall within the target region. The monitoring data storage module is configured to store pollution monitoring data obtained by performing multiple monitoring operations on a catchment outlet of the reference sub-catchment region of each characteristic region within the target region in a preset year. The parameter calculation module is configured to calculate a reference runoff pollution load equivalent of each reference sub-catchment region in the preset year based on the runoff pollution monitoring data, establish a set of load-factor relational set of equations based on the reference runoff pollution load equivalents of each reference sub-catchment region within each characteristic region and the load characteristic factors of each reference catchment outlet, and the set of load-factor relational set of equations are solved to obtain a characteristic coefficient corresponding to each load characteristic factor. The load calculation module is configured to determine the runoff pollution load of each catchment region based on the load characteristic factors of each catchment region corresponding to the target outfall and the corresponding characteristic coefficients, so as to rapidly achieve calculating the target runoff pollution load of the target outfall within the target region based on each runoff pollution loads.

It should be noted that although the scenario diagram illustrates the modules and their logical sequence, in certain situations, the technical solutions shown or described herein may be executed using modules and logical sequences different from those provided herein.

The technical solutions of the present application and how the technical solutions of the present application solve the aforementioned technical problems are described in detail below with reference to specific embodiments. The following specific embodiments may be combined with each other, and the same or similar concepts or processes may not be described repeatedly in certain embodiments. The embodiments of the present application will be described below in combination with the drawings.

FIG. 4 illustrates a flowchart diagram of a runoff pollution load calculation method provided by an embodiment of the present application. The method may be executed by a runoff pollution load calculation device, which may be a server or an electronic device. The following description is given by taking an electronic device as an example. The method in the present embodiment may be implemented through software, hardware, or a combination of both. As shown in FIG. 4, the method includes the following steps:

S210: determining a target outfall of a runoff pollution load to be calculated within a target region.
wherein the rain gauge and the sampler are arranged at the target outfall of the runoff pollution load to be calculated and are connected to the data processing device in a communication way, the sampler includes a sampling head, and the sampling head includes an outer protective grid and an inner fine filter mesh, the sampler is connected to the water quality detection device in a piping connection way, the water quality detection device receives wastewater collected by the sampler through a piping for detecting water quality, a water quality detection result includes pollutant concentrations, after the data processing device receives flow data sent by the flow meter and pollutant concentrations sent by the water quality detection device, the load calculation system calculates the runoff pollution load using the following formula:

$$M = {\int }_{0}^{T} {C}_{t} {Q}_{t} dt = {\sum }_{j = 1}^{n} {C}_{j} {Q}_{j} Δ t$$

wherein M represents a runoff pollution load after a single rainfall; Cₜ represents runoff pollutant concentrations of a rainfall at time t, measured in mg/L; Qₜ represents a runoff instantaneous flow of a rainfall at time t, measured in m³/s; Cⱼ represents runoff pollutant concentrations of a rainfall during a jth sampling, measured in mg/L; Qⱼ represents a runoff instantaneous flow of a rainfall during a jth sampling, measured in m³/s; Δt represents a time interval between two sampling, measured in min.

Wherein the target region includes a plurality of characteristic regions with different regional relevant characteristics, each of the plurality of characteristic regions includes a plurality of sub-catchment regions, the target region includes a plurality of outfalls, and each of the plurality of outfalls collects a plurality of runoff pollution loads from different sub-catchment regions.

In the present embodiment, the target region may be understood as any region experiencing surface runoff pollution. For example, the target region may be the urban built-up region of a certain city in the middle and lower reaches of the Yangtze River basin. Due to a large size of the target region and varying characteristics across different locations therein, the calculated runoff pollution load results differ across different locations. Therefore, in the prior art, the target region may be divided into multiple characteristic regions. Furthermore, in order to facilitate the rapid and accurate pollution load calculation, the characteristic regions are further subdivided into a plurality of sub-catchment regions. It should be noted that due to geographical characteristics, the target region contains a plurality of outfalls for discharging surface runoff pollution, and each of the plurality of outfalls collects a plurality of runoff pollution loads from different sub-catchment regions.

In the prior art, in order to subsequently rapidly and accurately calculate the target runoff pollution load corresponding to the target outfall within the target region, in the embodiment of the present application, the target region is divided into a plurality of characteristic regions based on regional relevant characteristics therein.

Optionally, a process of obtaining characteristic regions in the present application may specifically include: obtaining data of regional relevant characteristics within the target region that affects runoff pollution loads in different regions, and performing functional region division on the target region based on the data of regional relevant characteristics to obtain a plurality of characteristic regions corresponding to the target region.

In the prior art, regional relevant characteristics within the target region that affects runoff pollution loads in different regions may include, but are not limited to: built-up region functional characteristics, population density, rainwater pipe network coverage rate, topography, and per capita GDP, either individually or in combination.

Specifically, the target region may be divided based on a distribution of population density and human activity characteristics on the surface layer within the target region to obtain a plurality of characteristic regions. Specifically, the target region may be divided based on rainwater pipe network coverage rate or and regional topography of the target region to obtain a plurality of characteristic regions. Of course, the target region may be divided based on other characteristics. The present application does not impose specific limitations on the division criteria for characteristic regions.

For example, the target region of the technical solution of the present application may include several (less than or equal to 4) characteristic regions, such as core commercial districts, residential regions, industrial clusters, and low-impact development zones.

In the embodiments of the present application, sub-catchment regions can be understood as a plurality of sub regions obtained by further dividing the characteristic regions. Specifically, the aforementioned characteristic regions can also be understood as a plurality of catchment regions resulting from dividing the target region. However, in the prior art, when the calculated results of runoff pollution load obtained from an excessively large or excessively small catchment area are used as the basis for subsequent engineering treatment, their reliability will be relatively low. Therefore, based on obtaining a plurality of regional characteristics contained within the target region, each regional characteristic is further subdivided to yield a plurality of sub-catchment regions contained within each characteristic region.

Optionally, a process of obtaining sub-catchment regions in the present application may specifically include: performing catchment region division on a current characteristic region based on rainfall catchment ranges to obtain a plurality of sub-catchment regions corresponding to the current characteristic region.

In the prior art, taking any characteristic region as an example, catchment region division is performed on the watershed region of the characteristic region based on rainfall catchment ranges thereof to obtain at least one sub-catchment regions thereof. For example, in order to rapidly calculate the runoff pollution loads based on sub-catchment regions while to ensure high reliability of the results, the regional area of sub-catchment regions in the present application should preferably be controlled within 2-3 km².

On this basis foundation, considering the geographic characteristics of the target region, sub-catchment regions corresponding to each outfall within the target region are satisfied. Specifically, for any outfall, it is determined that runoff pollutants of which sub-catchment regions within the target area collects at the current outfall and are discharged through the current outfall. Further, corresponding relationships between each outfall and catchment region thereof are formed as a mapping table, so that when calculating the runoff pollution load of any outfall in the target region by taking it as the target outfall, the corresponding multiple sub-catchment regions can be quickly determined first, and then the runoff pollution load of the target outfall can be obtained by calculating the runoff pollution load of the sub-catchment regions.

S220: for any sub-catchment region corresponding to the target outfall, obtaining load characteristic factors corresponding to a current sub-catchment region and characteristic coefficients corresponding to the load characteristic factors when calculating a runoff pollution load based on the load characteristic factors;

In the embodiments of the present application, the load characteristic factors can be understood as factors which affect the pollution load formed when runoff pollutants from each of the plurality of sub-catchment regions collects at a catchment outlet. The characteristic coefficient can be understood as a computational parameter that characterizes the differences in runoff pollution load of sub-catchment areas affected by different characteristic regions. Specifically, the characteristic coefficients are determined based on load characteristic factors corresponding to a plurality of preset sub-catchment regions within the target region and a runoff pollution load equivalent in a preset year.

It can be explained that a runoff pollution load equivalent can be understood as a pollution load corresponding to a unit area within a preset sub-catchment region. That is, when determining the runoff pollution load equivalent, it is necessary to first determine the runoff pollution load collected by the sub-catchment region, and then determine the runoff pollution load equivalent of the sub-catchment region based on the runoff pollution load and the area of the sub-catchment region.

It is further explained that, for any sub-catchment region, each sub-catchment region within a characteristic region is divided into a reference sub-catchment region and a plurality of other sub-catchment regions. For example, taking any characteristic region as an example, the reference sub-catchment region can be any randomly selected sub-catchment region within the current characteristic region. Of course, in order to facilitate subsequent parameter calculations, the reference sub-catchment region in the prior art is a sub-catchment region within the current characteristic region that exhibits strong regional correlation with other sub-catchment regions. Specifically, a correlation calculation is performed on each sub-catchment region based on regional correlation characteristics thereof, so as to obtain a sub-catchment region with the highest regional correlation among all sub-catchment regions, and the sub-catchment region is determined as the reference sub-catchment region in the current characteristic region.

On this basis, a calculation process for characteristic coefficients In the embodiments of the present application specifically includes: for any characteristic region, determining a reference sub-catchment region within a current characteristic region, obtaining runoff pollution monitoring data of the reference sub-catchment region in the preset year, and determining a reference runoff pollution load equivalent of the reference sub-catchment region in the preset year based on the runoff pollution monitoring data; and obtaining reference load characteristic factors of a reference sub-catchment regions corresponding to each of the plurality of characteristic regions, and based on each reference load characteristic factor and each reference runoff pollution load equivalent, determining the characteristic coefficients corresponding to the load characteristic factors when calculating runoff pollution load based on the load characteristic factors.

It can be explained that the above-mentioned calculation of the regional load characteristics factor may achieve to determine differences between different sub-catchment regions by exploring common factors and characteristic factors existing in different sub-catchment regions, then perform the runoff pollution load calculation on a small number of sub-catchment regions, and correct the calculated runoff pollution load according to the aforementioned differences to obtain runoff pollution load of other sub-catchment regions, thereby achieving the rapid obtaining of the target runoff pollution load corresponding to the target region.

Specifically, in the embodiments of the present application, when calculating the characteristic coefficients, it is required to pre-determine the reference runoff pollution load equivalents of a reference sub-catchment region of each characteristic region in a preset year, along with the load characteristic factors corresponding to each reference sub-catchment region. On this basis, a set of relational equations is constructed for the above two types of parameters, and the characteristic coefficient is determined according to the solution results of the set of relational equations.

It should be understood that the preset year may be interpreted as any selected year in the embodiments of the present application, such as but not limited to the current year or other years prior to the current year that satisfy the preset rainfall conditions.

Optionally, a specific process for determining a reference runoff pollution load equivalent in the embodiments of the present application may include: obtaining a predetermined runoff pollution load statistical algorithm, and determining the reference runoff pollution load of the reference sub-catchment region based on the runoff pollution load statistical algorithm and the runoff pollution monitoring data; and performing unit area runoff pollution load statistical processing on the reference runoff pollution load to determine the reference runoff pollution load equivalent corresponding to the reference sub-catchment region in the preset year.

In the embodiments of the present application, the runoff pollution monitoring data may be understood as the monitoring data obtained from 10-15 pollutant monitoring sessions conducted at the reference catchment outlet corresponding to the reference sub-catchment region in the preset year. For example, the runoff pollution monitoring data includes but is not limited to data such as rainfall runoff value, pollutant concentration data, and the like.

For example, a specific formula for calculating the reference runoff pollution load may be:

$$La = {C}_{F} \times Ψ \times A \times P \times C \times 0 \text{.01} ;$$

where La represents the reference runoff pollution load for the reference sub-catchment region; C_{F} represents a correction factor for correcting rainfall events which does not generate surface runoff (a proportion of rainfall events which generate runoff relative to total rainfall events), typically set at 0.9; Ψ represents an average runoff coefficient across a plurality of sub-catchment regions; A represents a catchment area of a reference sub-catchment region; P represents an annual rainfall value in the preset year; C represents an average pollutant concentration at the reference outlet in the preset year, statistically derived from monitoring data of 10 to 15 rainfall events.

Specifically, the obtained runoff pollution monitoring data is substituted into the above formula to obtain the reference runoff pollution load for the reference sub-catchment region in each target region in the preset year.

For example, in the present embodiment, COD (Chemical Oxygen Demand) is used as the representative pollution indexes for calculating a pollution load. The reference runoff pollution load parameters corresponding to the reference catchment outlets of the reference sub-catchment regions of the four characteristic regions within the target region are shown in the table below:

TABLE 1
Table of Reference Runoff Pollution Load Parameters

| | reference | | | | | |
|---|---|---|---|---|---|---|
| characteristic | catchment | | | | | |
| regions | outlet | C_{F} | Ψ | A(hn²) | P(nm) | C(ng/L) |
| core | 1 | 0.9 | 0.65 | 236 | 1532 | 186.3 |
| commercial | | | | | | |
| districts | | | | | | |
| residential | 2 | 0.9 | 0.6 | 274 | 1532 | 196.7 |
| regions | | | | | | |
| industrial | 3 | 0.9 | 0.7 | 218 | 1532 | 125.8 |
| clusters | | | | | | |
| low-impact | 4 | 0.9 | 0.3 | 238 | 1532 | 94.2 |
| development | | | | | | |
| zones | | | | | | |

When monitoring data is only performed at the reference catchments outlet within the characteristic regions, the volume of monitored data is relatively small and the sampling and monitoring methods are consistent for different regions. It achieves a reductions in monitoring errors and an improvement in data accuracy, thereby ensuring the accuracy of pollution load calculation.

Furthermore, unit region runoff pollution load statistical processing is performed on the reference runoff pollution load of the reference sub-catchment region to determine the reference runoff pollution load equivalent corresponding to the reference sub-catchment region in the preset year. Specifically, a method for unit region runoff pollution load statistical processing can be implemented by dividing the reference runoff pollutant load of any reference sub-catchment region by a corresponding regional area thereof, so as to obtain the reference runoff pollution load equivalent corresponding to the reference sub-catchment region in the preset year.

For example, the processing expression used for unit area processing may be:

$$S = \frac{La}{Ms} ;$$

Wherein, S represents the reference runoff pollution load equivalent of the reference sub-catchment region; La represents the reference runoff pollution load of the reference sub-catchment region; and Ms represents an area of the reference sub-catchment region.

In the embodiments of the present application, on the basis of calculating the reference runoff pollution load equivalent corresponding to the reference sub-catchment region within each characteristic region in the preset year, the load characteristic factors of each characteristic region are obtained, a set of equations is then constructed based on each reference runoff pollution load equivalent and each load characteristic factor, and the set of equations are solved to obtain the characteristic coefficients.

Optionally, a process of obtaining the characteristic coefficients may specifically include:
for any characteristic region, establishing a load-factor relationship equation between the reference load characteristic factors and the reference runoff pollution load equivalent within the current characteristic region; and constructing a set of load-factor relational set of equations based on the load-factor relationship equation corresponding to each of the plurality of characteristic regions, and determining the characteristic coefficients based on the set of load-factor relational set of equations and predefined coefficient correlations among each of the characteristic coefficients.

In the prior art, since rainfall characteristics, pollution deposition patterns, and socioeconomic activities are largely consistent within the same city or region, calculating the runoff pollution loads is minimally affected by the above-mentioned factors. Furthermore, as the area of each sub-catchment region is 2-3 km², calculating the runoff pollution loads is minimally affected by pipe network convergence. Consequently, the load characteristic factors of calculating the runoff pollution loads include road-to-square ratio, building roof ratio, green space ratio, water surface/wetland ratio, and terrain slope factor.

On the aforesaid basis, for any characteristic region, a load-factor relationship equation is constructed between the reference load characteristic factors and the reference runoff pollution load equivalent. For example, the equation expression may be:

$${S}_{i} = {K}_{pi} \times ( {k}_{1 i} {A}_{i} + {k}_{2 i} {B}_{i} + {k}_{3 i} {C}_{i} + {k}_{4 i} {D}_{i} ) ;$$

wherein, Sᵢ represents the reference runoff pollution load equivalent of the reference sub-catchment region within any characteristic region; Aᵢ represents the road-to-square ratio; Bᵢ denotes the building roof ratio; Cᵢ represents the green space ratio; Dᵢ represents the water surface/wetland ratio; Kₚᵢ represents the terrain slope factor; k₁ᵢ represents a characteristic coefficient corresponding to the road-to-square ratio; k₂ᵢ represents a characteristic coefficient corresponding to the building roof ratio; k3ᵢ represents a characteristic coefficient corresponding to the green space ratio; k₄ᵢ represents a characteristic coefficient corresponding to the water surface/wetland ratio.

Furthermore, the load-factor relational set of equations corresponding to the four characteristic regions derived from the aforementioned region dividing method are calculated separately. These four equation expressions are then combined to form a set of load-factor relational set of equations. For example, the specific set of equations may be:

$${S}_{1} = {K}_{p 1} \times ( {k}_{11} {A}_{1} + {k}_{21} {B}_{1} + {k}_{31} {C}_{1} + {k}_{41} {D}_{1} ) ;$$

$${S}_{2} = {K}_{p 2} \times ( {k}_{12} {A}_{2} + {k}_{22} {B}_{2} + {k}_{32} {C}_{2} + {k}_{42} {D}_{2} ) ;$$

$${S}_{3} = {K}_{p 3} \times ( {k}_{13} {A}_{3} + {k}_{23} {B}_{3} + {k}_{33} {C}_{3} + {k}_{43} {D}_{3} ) ;$$

$${S}_{4} = {K}_{p 4} \times ( {k}_{14} {A}_{4} + {k}_{24} {B}_{4} + {k}_{34} {C}_{4} + {k}_{44} {D}_{4} ) ;$$

On this basis, in order to solve for the characteristic coefficients corresponding to each load characteristic factor of the characteristic regions in the set of equations, it is necessary to obtain the predefined coefficient correlations between the characteristic coefficients. These predefined coefficient correlations are then substituted into the aforementioned set of equations to facilitate the coefficient solution.

In the embodiments of the present application, the predefined coefficient correlations among characteristic coefficients may specifically be: equal characteristic coefficients corresponding to the building roof ratios in different characteristic regions, equal characteristic coefficients corresponding to the water surface/wetland ratios in different characteristic regions, and a predetermined proportional relationship between the characteristic coefficients corresponding to the green space ratio and the characteristic coefficients corresponding to the road-to-square ratios in the same characteristic region.

In the prior art, since rainfall pollutants generated by rainfalls are largely consistent within the same urban built-up region, and architectural styles are generally uniform across same urban built-up region, the water surface pollution load and building roof pollution load are essentially identical across all characteristic regions within the target region. Thus, k₄₁=k₄₂=k₄₃=k₄₄, and k₂₁=k₂₂=k₂₃=k₂₄.

Due to urban planning and construction, the green space load equivalent within the same built-up region is directly related to roads and squares. In the prior art, it is generally set as k₃ᵢ=(0.15-0.3)k₁ᵢ.

In the prior art, Kₚᵢ is related to the regional slope gradient of the sub-catchment region. When slope gradients across different regions are essentially consistent, Kₚᵢ is set to a uniform value of 1. When they differ, appropriate adjustments are made.

On the aforesaid basis, the factor values and respective proportional values of each load characteristic factor corresponding to each characteristic region are obtained. In addition, the coefficient parameters after calculating each coefficient based on the above-mentioned coefficient correlations are obtained. The coefficient parameters and factor values are then substituted into the above-mentioned set of equations to solve the set of equations, and the solved values of each characteristic coefficient are obtained.

For example, the load-factor relational set of equations are constructed and fitted based on the reference runoff pollution load equivalents S and respective load characteristic factors of four distinct characteristic regions for the preset year (each equation is required to be fitted with greater than or equal to 4 sets of data that are substituted). The resulting characteristic coefficients are as follows:

$${S}_{1} = 5979.4 {A}_{1} + 673.4 {B}_{1} + 1136.1 {C}_{1} + 197.9 {D}_{1} ;$$

$${S}_{2} = 6269.5 {A}_{2} + 673.4 {B}_{2} + 1630.1 {C}_{2} + 197.9 {D}_{2} ;$$

$${S}_{3} = 1946.5 {A}_{3} + 673.4 {B}_{3} + 447.7 {C}_{3} + 197.9 {D}_{3} ;$$

$${S}_{4} = 430.4 {A}_{4} + 673.4 {B}_{4} + 116.2 {C}_{4} + 197.9 {D}_{4} ;$$

Wherein, S₁, S₂, S₃, and S₄ represent the reference runoff pollution loads of the reference sub-catchment regions of core commercial districts, residential regions, industrial clusters, and low-impact development zones, respectively; Aᵢ, Bᵢ, Cᵢ, and Dᵢ represent the load characteristic factors of each reference sub-catchment region.

S230: determining a runoff pollution load of the current sub-catchment region in the preset year based on the load characteristic factors and the characteristic coefficients.

In the embodiments of the present application, the target runoff pollution load can be understood as a runoff pollution load discharged through the target outfall within the target region.

It should be noted that since each outfall collects a plurality of runoff pollution loads from different sub-catchment regions, calculating the target runoff pollution load corresponding to the target outfall requires prior calculation of the runoff pollution loads corresponding to each sub-catchment region of the target outfall.

Specifically, for any sub-catchment region corresponding to the target outfall, the load characteristic factor for the current sub-catchment region is obtained. For example, in the present embodiment, take calculating the other five sub-catchment regions within the urban built-up region as an example. The following table illustrates the load characteristic factor information for the five sub-catchment regions:

TABLE 2
Table of Load Characteristic Factor
Information for Sub-Catchment Regions

| | Sub- | | | | | |
|---|---|---|---|---|---|---|
| | catchment | | | | | |
| | Regions | A′ᵢ | B′ᵢ | C′ᵢ | D′ᵢ | |
| Characteristic regions | NO | (%) | (%) | (%) | (%) | M(hm²) |
| Core commercial districts | 1 | 17 | 69 | 11 | 3 | 245 |
| Residential regions | 2 | 16 | 53 | 22 | 9 | 218 |
| Industrial clusters | 3 | 45 | 49 | 5 | 1 | 239 |
| Low-impact | 4 | 21 | 31 | 34 | 14 | 267 |
| development zones | | | | | | |
| Residential regions | 5 | 20 | 51 | 23 | 6 | 262 |

Furthermore, the load characteristic factors and the characteristic coefficients calculated on the basis of above-mentioned embodiment are substituted into the load-factor relationship equation constructed in the above above-mentioned embodiment to obtain the runoff pollution load corresponding to the current sub-catchment region.

For example, an expression for calculating the runoff pollution load of any sub-catchment region may be:

$${U}_{i} = {K}_{pi} \times ( {k}_{1 i} \times {A}_{i}^{′} + {k}_{2 i} \times {B}_{i}^{′} + {k}_{3 i} \times {C}_{i}^{′} + {k}_{4 i} \times {D}_{i}^{′} ) ;$$

Wherein, Ui represents a runoff pollution load for any sub-catchment region corresponding to the target outfall; A′ᵢ, B′ᵢ, C′ᵢ, and D′ᵢ, represent road-to-square ratio, building roof ratio, green space ratio, water surface/wetland ratio of each sub-catchment region, respectively; k₁ᵢ, k₂ᵢ, k₃ᵢ, and k₄ᵢ represent characteristic coefficients corresponding to each of the above proportion factors; Kₚᵢ represents the slope gradient factor.

Furthermore, since the aforementioned runoff pollution load represents a pollution load per unit area of the sub-catchment region, in order to calculate the target runoff pollution load, it is required to determine the runoff pollution load for the sub-catchment region based on a regional area thereof.

For example, the expression for calculating a runoff pollution load may be:

$${L}_{i} = {U}_{i} \times {M}_{i} ;$$

Wherein, Lᵢ represents a target runoff pollution load for any sub-catchment region; Ui represents a runoff pollution load for any sub-catchment region; Mi represents a catchment area of the sub-catchment region.

For example, the runoff pollution loads and the runoff pollution load information calculated for the five sub-catchment regions are shown in the table below:

TABLE 3
Table of Runoff Pollution Load Information

| | Sub-catchment | Uᵢ | Lᵢ |
|---|---|---|---|
| Characteristic regions | Regions NO | (kg/hm²) | (kg) |
| Core commercial districts | 1 | 1612.1 | 394952.4 |
| Residential regions | 2 | 1736.4 | 378545.8 |
| Industrial clusters | 3 | 1230.2 | 294030.9 |
| Low-impact development zones | 4 | 366.3 | 97816.7 |
| Residential regions | 5 | 1984.1 | 519840.5 |

S240: determining a sum of runoff pollution loads for each sub-catchment region corresponding to the target outfall in the preset year, and adjusting the sum of runoff pollution loads based on a time correction factor between a target year and the preset year to determine a target runoff pollution load of the target outfall in the target year.

In the embodiments of the present application, since the target outfall collects runoff pollutants from a plurality of preset sub-catchment regions, on the basis that obtaining the runoff pollution loads corresponding to each sub-catchment region of the target discharge point based on the aforementioned embodiment, all runoff pollution loads are summed to obtain a sum of all runoff pollution loads in the preset year.

Furthermore, since the characteristic coefficients are determined using data in the preset year, when calculating the target runoff pollution load of a target region using data in a different year, in order to improve data accuracy, a predetermined time correction factor between a target year and the preset year may be used to adjust the calculated sum of runoff pollution loads to determine a runoff pollution load in the target year, i.e., a target runoff pollution load of the target outfall in the target year. Optionally, the correction factors for different years in the present application are related to rainfall intensity, rainfall amount, and annual pollution characteristics. If the target year and the preset year are different, the time correction factor is generally determined to be 0.8-1.2.

Of course, in the above-mentioned embodiment, the time correction factor may also be used in advance to correct the runoff pollution load when calculating the runoff pollution load corresponding to each sub-catchment region. The corrected runoff pollution loads are then summed to obtain the target runoff pollution load. In the embodiments of the present application, the execution order of correction and summation is not specifically limited.

For example, the expression for determining the target runoff load based on the runoff pollution loads may be:

$$L = \sum {K}_{n} {L}_{i} ;$$

Wherein, L represents the target runoff pollution load; Kₙ represents the time correction factor; and Lᵢ represents the runoff pollution load of any sub-catchment region.

For example, when the target region is the urban built-up region of a city in the middle and lower reaches of the Yangtze River basin, the sub-catchment regions corresponding to the target outfall within the target region are sub-catchment region 1 and sub-catchment region 2 as described above. Therefore, based on the above expression, the target runoff pollution load (measured in COD) for the target outfall in the target year is calculated, and the result is obtained as follows: L=394952.4+378545.8=773498.2 (kg).

In the above-mentioned technical solutions, through the reference runoff pollution load equivalent of the pre-selected reference sub-catchment region within the target region in the preset year, the load characteristic factors which affect the pollution load formed when runoff pollutants from each of the plurality of sub-catchment regions collect at a catchment outlet and the corresponding characteristic coefficients thereof are determined, so as to achieve the rapid calculation for the runoff pollution load of each catchment region, and the rapid calculation of the runoff pollution load of the target outfalls within the target region, thereby solving the technical problems that the calculation results are difficult to meet the timeliness and accuracy requirements for the rapid calculation due to large monitoring data volume, repeated monitoring, large random monitoring errors and long load calculation cycles, and achieving to improve efficiency and accuracy of a runoff pollution load calculation result.

FIG. 5 illustrates a structural diagram of a runoff pollution load calculation apparatus provided by an embodiment of the present application. Referring to FIG. 5, the apparatus includes: a target outfall determining module 310, a data obtaining module 320, a runoff pollution load determining module 330, and a target runoff pollution load determining module 340.

The target outfall determining module 310 is configured to determine a target outfall of a runoff pollution load to be calculated within a target region; wherein the rain gauge and the sampler are arranged at the target outfall of the runoff pollution load to be calculated and are connected to the data processing device in a communication way, the sampler includes a sampling head, and the sampling head includes an outer protective grid and an inner fine filter mesh, the sampler is connected to the water quality detection device in a piping connection way, the water quality detection device receives wastewater collected by the sampler through a piping for detecting water quality, a water quality detection result includes pollutant concentrations, after the data processing device receives flow data sent by the flow meter and pollutant concentrations sent by the water quality detection device, the load calculation system calculates the runoff pollution load using the following formula:

$$M = {\int }_{0}^{T} {C}_{t} {Q}_{t} dt = {\sum }_{j = 1}^{n} {C}_{j} {Q}_{j} Δ t ;$$

wherein M represents a runoff pollution load after a single rainfall; Cₜ represents runoff pollutant concentrations of a rainfall at time t, measured in mg/L; Qₜ represents a runoff instantaneous flow of a rainfall at time t, measured in m³/s; Cⱼ represents runoff pollutant concentrations of a rainfall during a jth sampling, measured in mg/L; Qⱼ represents a runoff instantaneous flow of a rainfall during a jth sampling, measured in m³/s; Δt represents a time interval between two sampling, measured in min;
wherein the target region includes a plurality of characteristic regions with different regional relevant characteristics, each of the plurality of characteristic regions includes a plurality of sub-catchment regions, the target region includes a plurality of outfalls, and each of the plurality of outfalls collects a plurality of runoff pollution loads from different sub-catchment regions.

The data obtaining module 320 is configured to, for any sub-catchment region corresponding to the target outfall, obtain load characteristic factors corresponding to a current sub-catchment region and characteristic coefficients corresponding to the load characteristic factors when calculating a runoff pollution load based on the load characteristic factors, wherein the load characteristic factors are factors which affect the pollution load formed when runoff pollutants from each of the plurality of sub-catchment regions collects at a catchment outlet, and the characteristic coefficients are determined based on load characteristic factors corresponding to a plurality of preset sub-catchment regions within the target region and a runoff pollution load equivalent in a preset year;
The runoff pollution load determining module 330 is configured to determine a runoff pollution load of the current sub-catchment region in the preset year based on the load characteristic factors and the characteristic coefficients;
The target runoff pollution load determining module 340 is configured to determine a sum of runoff pollution loads for each sub-catchment region corresponding to the target outfall in the preset year, and adjust the sum of runoff pollution loads based on a time correction factor between a target year and the preset year to determine a target runoff pollution load of the target outfall in the target year.

Optionally, the apparatus further includes:
a characteristic region determining unit, configured to, before determining a target outfall of a runoff pollution load to be calculated within a target region, obtain data of regional relevant characteristics within the target region that affects runoff pollution loads in different regions, and perform functional region division on the target region based on the data of regional relevant characteristics to obtain a plurality of characteristic regions corresponding to the target region; and
a sub-catchment region determining unit, configured to, for any characteristic region, perform catchment region division on a current characteristic region based on rainfall catchment ranges to obtain a plurality of sub-catchment regions corresponding to the current characteristic region.

Optionally, each of the plurality of characteristic regions includes a reference sub-catchment region and other sub-catchment regions;

Correspondingly, the data obtaining module 320 includes:
a reference runoff pollution load equivalent determining sub-module, configured to, for any characteristic region, determine a reference sub-catchment region within a current characteristic region, obtain runoff pollution monitoring data of the reference sub-catchment region in the preset year, and determine a reference runoff pollution load equivalent of the reference sub-catchment region in the preset year based on the runoff pollution monitoring data; and
a characteristic coefficient determining sub-module, configured to obtain reference load characteristic factors of a reference sub-catchment regions corresponding to each of the plurality of characteristic regions, and based on each reference load characteristic factor and each reference runoff pollution load equivalent, determine the characteristic coefficients corresponding to the load characteristic factors when calculating runoff pollution load based on the load characteristic factors
a characteristic coefficient determining sub-module, configured to obtain reference load characteristic factors of a reference sub-catchment regions corresponding to each of the plurality of characteristic regions, and based on each reference load characteristic factor and each reference runoff pollution load equivalent, determine the characteristic coefficients corresponding to the load characteristic factors when calculating runoff pollution load based on the load characteristic factors.

Optionally, the reference runoff pollution load equivalent determining sub-module includes:
a reference runoff pollution load equivalent determining unit, configured to obtain a predetermined runoff pollution load statistical algorithm, and determine the reference runoff pollution load of the reference sub-catchment region based on the runoff pollution load statistical algorithm and the runoff pollution monitoring data; and perform unit region runoff pollution load statistical processing on the reference runoff pollution load to determine the reference runoff pollution load equivalent corresponding to the reference sub-catchment region in the preset year.

Optionally, the characteristic coefficient determining sub-module includes:
a load-factor relationship equation determining unit, configured to, for any characteristic region, establish a load-factor relationship equation between the reference load characteristic factors and the reference runoff pollution load equivalent within the current characteristic region; and
a characteristic coefficient determining unit, configured to construct a set of load-factor relational set of equations based on the load-factor relationship equation corresponding to each of the plurality of characteristic regions, and determine the characteristic coefficients based on the set of load-factor relational set of equations and predefined coefficient correlations among each of the characteristic coefficients.

Optionally, the load characteristic factors include road-to-square ratio, building roof ratio, green space ratio, water surface/wetland ratio, and terrain slope factor.

Correspondingly, the load-factor relationship equation includes:

$${S}_{i} = {K}_{pi} \times ( {k}_{1 i} {A}_{i} + {k}_{2 i} {B}_{i} + {k}_{3 i} {C}_{i} + {k}_{4 i} {D}_{i} ) ;$$

wherein, Sᵢ represents the reference runoff pollution load equivalent of the reference sub-catchment region within any characteristic region; Aᵢ represents the road-to-square ratio; Bᵢ denotes the building roof ratio; Cᵢ represents the green space ratio; Dᵢ represents the water surface/wetland ratio; Kₚᵢ represents the terrain slope factor; k₁ᵢ represents a characteristic coefficient corresponding to the road-to-square ratio; k₂ᵢ represents a characteristic coefficient corresponding to the building roof ratio; k3ᵢ represents a characteristic coefficient corresponding to the green space ratio; k₄ᵢ represents a characteristic coefficient corresponding to the water surface/wetland ratio

Optionally, the coefficient correlations includes: equal characteristic coefficients corresponding to the building roof ratios in different characteristic regions, equal characteristic coefficients corresponding to the water surface/wetland ratios in different characteristic regions, and a predetermined proportional relationship between the characteristic coefficients corresponding to the green space ratio and the characteristic coefficients corresponding to the road-to-square ratios in the same characteristic region.

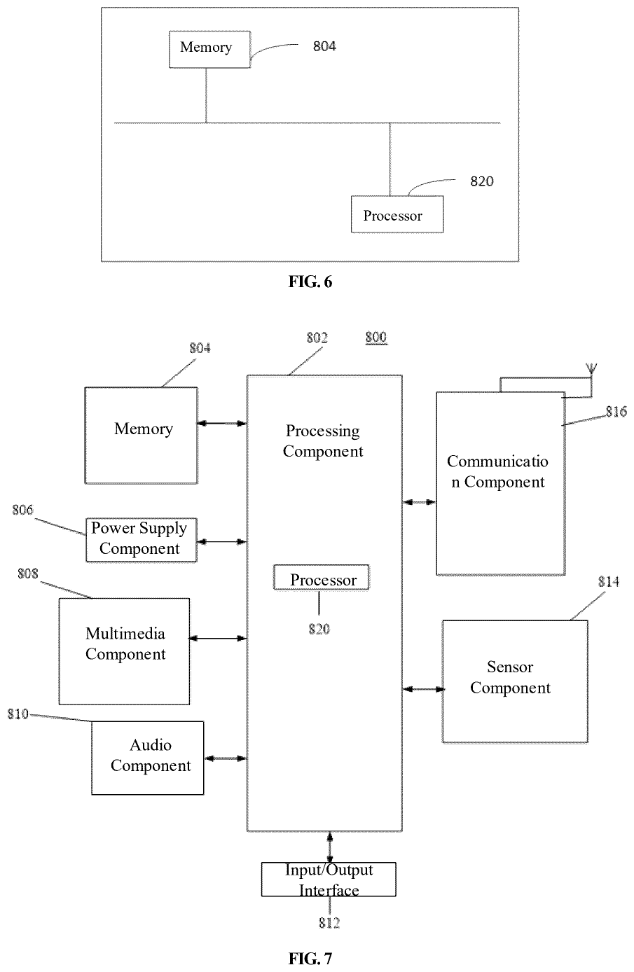

FIG. 6 illustrates a structural diagram of an electronic device provided by an embodiment of the present application. As shown in FIG. 6, the electronic device of the embodiment of the present application may include:
at least one processor 820; and a memory 804 connected to the at least one processor in a communication way;
wherein the memory 804 has instructions stored thereon and executable by the at least one processor 820. The instructions are executed by the at least one processor 820 to enable the server to perform the method described in any one of the above embodiments.

Optionally, the memory 804 may be either independent or integrated with the processor 820.

The implementation principles and technical effects of the electronic device provided in the embodiment of the present application may be referenced from the above-mentioned embodiments and are not repeated herein.

The present application further provides a computer-readable storage medium storing computer-executable instructions. When executed by a processor, the instructions are configured to implement the method described in any one of the foregoing embodiments.

The present application also provides a computer program product, including computer program code, when executed by a processor, is configured to implements the method described in any one of the foregoing embodiments.

In several embodiments provided by the present application, it should be understood that the disclosed apparatus and methods may be implemented in other ways. For example, the apparatus embodiments described above are merely illustrative. The division of modules, for instance, represents only a logical functional division; other divisions may be used in an actual implementation, such as combining a plurality of modules or integrating them into another system, or omitting certain features or not executing them.

The integrated modules implemented as software functional modules may be stored on a computer-readable storage medium. The above-mentioned manner that software functional modules may be stored on a computer-readable storage medium include a set of instructions for causing a computer device (which may be a personal computer, server, or network device, etc.) or processor to execute portions of the methods of the various embodiments of the present application.

It should be understood that the above-mentioned processor may be a Central Processing Unit (CPU), or may be other general-purpose processors, Digital Signal Processors (DSPs), Application Specific Integrated Circuits (ASICs), etc. The general-purpose processor may be a microprocessor, or the processor may be any conventional processor, etc. The steps of the methods disclosed herein may be implemented directly by a hardware processor or by a combination of hardware and software modules within a processor. The storage medium may include high-speed random access memory (RAM) and may also include non-volatile memory (NVM), such as at least one disk storage device, or may be a USB flash drive, portable hard drive, read-only memory (ROM), disk, or optical disc.

The aforementioned storage media may be implemented by any type of volatile or non-volatile storage device or a combination thereof, such as Static Random-Access Memory (SRAM), Electrically-Erasable Programmable Read-Only Memory (EEPROM), Erasable Programmable Read-Only Memory (EPROM), Programmable Read-Only Memory (PROM), Read-Only Memory (ROM), or other similar devices. EEPROM), Erasable Programmable Read-Only Memory (EPROM), Programmable Read-Only Memory (PROM), Read-Only Memory (ROM), magnetic storage, flash memory, disk, or optical disc. The storage medium may be any available medium accessible by a general-purpose or specialized computer.

An exemplary storage medium is coupled to the processor, so as to enable the processor to read information from and write information to the storage medium. Of course, the storage medium may also be an integral part of the processor. The processor and storage medium may be located within an Application Specific Integrated Circuit (ASIC). Alternatively, the processor and storage medium may exist as discrete components within a server or host device.

FIG. 7 illustrates a block diagram of a terminal electronic device provided by an embodiment of the present application. The electronic device may be a mobile phone, computer, digital broadcast terminal, message sending and receiving device, game console, tablet device, medical device, fitness device, personal digital assistant, etc.

The device 800 may include one or more of the following components: a processing component 802, a memory 804, a power supply component 806, a multimedia component 808, an audio component 810, an input/output interface 812, a sensor component 814, and a communication component 816.

The processing component 802 is typically configured to control overall operations of the device 800, such as those associated with display, phone calls, data communication, camera operation, and recording functions. The processing component 802 may include one or more processors 820 to execute instructions to implement all or part of the steps of the method described above. Additionally, the processing component 802 may include one or more modules to facilitate interactions between the processing component 802 and other components. For example, the processing component 802 may include a multimedia module to facilitate interactions between the multimedia component 808 and the processing component 802.

The memory 804 is configured to store various types of data to support operations on the device 800. Examples of such data include instructions for any application or method operating on the device 800, contact data, phonebook data, messages, pictures, videos, and so on. The memory 804 may be implemented by any type of volatile or non-volatile storage device, or a combination thereof, such as static random access memory (SRAM), electrically erasable programmable read-only memory (EEPROM), erasable programmable read-only memory (EPROM), programmable read-only memory (PROM), read-only memory (ROM), magnetic storage, flash memory, disks, or optical disks.

The power supply component 806 provides electrical power to various components of the device 800. The power supply component 806 may include a power management system, one or more power supplies, and other components associated with generating, managing, and distributing electrical power for the device 800.

The multimedia component 808 includes a screen that provides an output interface between the device 800 and the user. In some embodiments, the screen may include a liquid crystal display (LCD) and a touch panel (TP). If the screen includes a touch panel, it may be implemented as a touchscreen to receive input signals from the user. The touch panel includes one or more touch sensors to detect touches, swipes, and gestures on the touch panel. The touch sensors may detect not only the boundaries of touch or swipe actions but also the duration and pressure associated with the touch or swipe operations. In some embodiments, the multimedia component 808 includes a front camera and/or a rear camera. When the device 800 is in an operational mode, such as a capture mode or a video mode, the front camera and/or rear camera may receive external multimedia data. Each front camera and rear camera may be a fixed optical lens system or may have a focal length and optical zoom capability.

The audio component 810 is configured to output and/or input audio signals. For example, the audio component 810 includes a microphone (MIC) configured to receive external audio signals when the device 800 is in operational modes such as call mode, recording mode, and voice recognition mode. The received audio signals may be further stored in the memory 804 or transmitted via the communication component 816. In some embodiments, the audio component 810 further includes a speaker for outputting audio signals.

The input/output interface 812 provides an interface between the processing component 802 and the peripheral interface modules, which may include keyboards, click wheels, buttons, etc. These buttons may include but are not limited to: a home button, a volume button, a power button, and a lock button.

The sensor component 814 includes one or more sensors for providing status assessments of various aspects of the device 800. For example, the sensor assembly 814 may detect the on/off state of the device 800, the relative positioning of components (e.g., the display and numeric keypad of the device 800), also may detect changes in position of the device 800 or components thereof, the presence or absence of contact between the user and the device 800, orientation or acceleration/deceleration of the device 800, and temperature variations of the device 800. The sensor component 814 may include proximity sensors configured to detect the presence of nearby objects without physical contact. The sensor component 814 may also include photo sensors, such as CMOS or CCD image sensors, configured to use in imaging applications. In some embodiments, the sensor component 814 may further include accelerometers, gyroscopes, magnetic sensors, pressure sensors, or temperature sensors.

The communication component 816 is configured to facilitate wired or wireless communication between the device 800 and other devices. The device 800 may access wireless networks based on communication standards such as WiFi, 2G, or 3G, or combinations thereof. In an exemplary embodiment, the communication component 816 receives broadcast signals or broadcast-related information from an external broadcast management system via a broadcast channel. In an exemplary embodiment, the communication component 816 further includes a near-field communication (NFC) module to facilitate short-range communication. For example, the NFC module may be implemented based on radio frequency identification (RFID) technology, Infrared Data Association (IrDA) technology, ultra-wideband (UWB) technology, Bluetooth (BT) technology, and other technologies.

In exemplary embodiments, the device 800 may be implemented by one or more application-specific integrated circuits (ASICs), digital signal processors (DSPs), digital signal processing devices (DSPDs), programmable logic devices (PLDs), field-programmable gate arrays (FPGAs), controllers, microcontrollers, microprocessors, or other electronic components to execute the above-described method.

In exemplary embodiments, a non-transitory computer-readable storage medium is also provided, such as a memory 804 comprising instructions, wherein the instructions are executable by the processor 820 of the device 800 to execute the above-described method. For example, the non-transitory computer-readable storage medium may be a ROM, a random access memory (RAM), a CD-ROM, a tape, a floppy disk, and an optical data storage device, among others.

A non-transitory computer-readable storage medium, wherein when instructions stored thereon are executed by the processor of a terminal electronic device, the terminal electronic device is enabled to implement the method for the terminal electronic device described above.

Those skilled in the art, upon considering of the description and practice of the invention disclosed herein, will readily conceive other embodiments of the present application. The present application is intended to encompass any variations, purpose, or adaptations of the present application that follow the general principles of the present application and include common knowledge or conventional technical means in the art not disclosed herein. The specification and embodiments are merely illustrative, and the true scope and spirit of the present application are defined by the appended claims.

It should be understood that the present application is not limited to the precise structures described above and shown in the drawings, and various modifications and alterations may be made without departing from the scope thereof. The scope of the present application is defined solely by the appended claims.

The listing of claims:

1. A runoff pollution load calculation method, applied to a runoff water sampling apparatus, wherein the runoff water sampling apparatus comprises a rain gauge, a flow meter, a sampler, a water quality detection device and a data processing device, the data processing device comprises a preset load calculation system, and the method comprises:
determining a target outfall of a runoff pollution load to be calculated within a target region; wherein the rain gauge and the sampler are arranged at the target outfall of the runoff pollution load to be calculated and are connected to the data processing device in a communication way, the sampler comprises a sampling head, and the sampling head comprises an outer protective grid and an inner fine filter mesh, the sampler is connected to the water quality detection device in a piping connection way, the water quality detection device receives wastewater collected by the sampler through a piping for detecting water quality, a water quality detection result comprises pollutant concentrations, after the data processing device receives flow data sent by the flow meter and pollutant concentrations sent by the water quality detection device, the load calculation system calculates the runoff pollution load using the following formula:
$$M = {\int }_{0}^{T} {C}_{t} {Q}_{t} dt = {\sum }_{j = 1}^{n} {C}_{j} {Q}_{j} Δ t$$
wherein M represents a runoff pollution load after a single rainfall; Cₜ represents runoff pollutant concentrations of a rainfall at time t, measured in mg/L; Qₜ represents a runoff instantaneous flow of a rainfall at time t, measured in m³/s; Cⱼ represents runoff pollutant concentrations of a rainfall during a jth sampling, measured in mg/L; Qⱼ represents a runoff instantaneous flow of a rainfall during a jth sampling, measured in m³/s; Δt represents a time interval between two sampling, measured in min;
wherein the target region comprises a plurality of characteristic regions with different regional relevant characteristics, each of the plurality of characteristic regions comprises a plurality of sub-catchment regions, the target region comprises a plurality of outfalls, and each of the plurality of outfalls collects a plurality of runoff pollution loads from different sub-catchment regions;
for any sub-catchment region corresponding to the target outfall, obtaining load characteristic factors corresponding to a current sub-catchment region and characteristic coefficients corresponding to the load characteristic factors when calculating a runoff pollution load based on the load characteristic factors, wherein the load characteristic factors are factors which affect the pollution load formed when runoff pollutants from each of the plurality of sub-catchment regions collects at a catchment outlet, and the characteristic coefficients are determined based on load characteristic factors corresponding to a plurality of preset sub-catchment regions within the target region and a runoff pollution load equivalent in a preset year;
determining a runoff pollution load of the current sub-catchment region in the preset year based on the load characteristic factors and the characteristic coefficients; and
determining a sum of runoff pollution loads for each sub-catchment region corresponding to the target outfall in the preset year, and adjusting the sum of runoff pollution loads based on a time correction factor between a target year and the preset year to determine a target runoff pollution load of the target outfall in the target year.

2. The method according to claim 1, wherein, before determining a target outfall of a runoff pollution load to be calculated within a target region, the method further comprises:
obtaining data of regional relevant characteristics within the target region that affects runoff pollution loads in different regions, and performing functional region division on the target region based on the data of regional relevant characteristics to obtain a plurality of characteristic regions corresponding to the target region; and
for any characteristic region, performing catchment region division on a current characteristic region based on rainfall catchment ranges to obtain a plurality of sub-catchment regions corresponding to the current characteristic region.

3. The method according to claim 1, wherein each of the plurality of characteristic regions comprises a reference sub-catchment region and other sub-catchment regions;
correspondingly, the step of determining the characteristic coefficients based on load characteristic factors corresponding to a plurality of preset sub-catchment regions within the target region and a runoff pollution load equivalent in a preset year comprises:
for any characteristic region, determining a reference sub-catchment region within a current characteristic region, obtaining runoff pollution monitoring data of the reference sub-catchment region in the preset year, and determining a reference runoff pollution load equivalent of the reference sub-catchment region in the preset year based on the runoff pollution monitoring data; and
obtaining reference load characteristic factors of a reference sub-catchment regions corresponding to each of the plurality of characteristic regions, and based on each reference load characteristic factor and each reference runoff pollution load equivalent, determining the characteristic coefficients corresponding to the load characteristic factors when calculating runoff pollution load based on the load characteristic factors.

4. The method according to claim 3, wherein the step of determining a reference runoff pollution load equivalent of the reference sub-catchment region in the preset year based on the runoff pollution monitoring data comprises:
obtaining a predetermined runoff pollution load statistical algorithm, and determining the reference runoff pollution load of the reference sub-catchment region based on the runoff pollution load statistical algorithm and the runoff pollution monitoring data; and
performing unit area runoff pollution load statistical processing on the reference runoff pollution load to determine the reference runoff pollution load equivalent corresponding to the reference sub-catchment region in the preset year.

5. The method according to claim 3, wherein the step of, based on each reference load characteristic factor and each reference runoff pollution load equivalent, determining the characteristic coefficients corresponding to the load characteristic factors when calculating runoff pollution load based on the load characteristic factors comprises:
for any characteristic region, establishing a load-factor relationship equation between the reference load characteristic factors and the reference runoff pollution load equivalent within the current characteristic region; and
constructing a set of load-factor relational set of equations based on the load-factor relationship equation corresponding to each of the plurality of characteristic regions, and determining the characteristic coefficients based on the set of load-factor relational set of equations and predefined coefficient correlations among each of the characteristic coefficients.

6. The method according to claim 5, wherein the load characteristic factors comprise road-to-square ratio, building roof ratio, green space ratio, water surface/wetland ratio, and terrain slope factor;
correspondingly, the load-factor relationship equation comprises:
$${S}_{i} = {K}_{pi} \times ( {k}_{1 i} {A}_{i} + {k}_{2 i} {B}_{i} + {k}_{3 i} {C}_{i} + {k}_{4 i} {D}_{i} ) ;$$
wherein, Sᵢ represents the reference runoff pollution load equivalent of the reference sub-catchment region within any characteristic region; Aᵢ represents the road-to-square ratio; Bᵢ denotes the building roof ratio; Cᵢ represents the green space ratio; Dᵢ represents the water surface/wetland ratio; Kₚᵢ represents the terrain slope factor; k₁ᵢ represents a characteristic coefficient corresponding to the road-to-square ratio; k₂ᵢ represents a characteristic coefficient corresponding to the building roof ratio; k3ᵢ represents a characteristic coefficient corresponding to the green space ratio; k₄ᵢ represents a characteristic coefficient corresponding to the water surface/wetland ratio.

7. The method according to claim 6, wherein the coefficient correlations comprises: equal characteristic coefficients corresponding to the building roof ratios in different characteristic regions, equal characteristic coefficients corresponding to the water surface/wetland ratios in different characteristic regions, and a predetermined proportional relationship between the characteristic coefficients corresponding to the green space ratio and the characteristic coefficients corresponding to the road-to-square ratios in the same characteristic region.

8. A runoff pollution load calculation apparatus, applied to a runoff water sampling apparatus, wherein the runoff water sampling apparatus comprising a rain gauge, a flow meter, a sampler, a water quality detection device and a data processing device, the data processing device comprises a preset load calculation system, and the apparatus comprises:
a target outfall determining module, configured to determine a target outfall of a runoff pollution load to be calculated within a target region; wherein the rain gauge and the sampler are arranged at the target outfall of the runoff pollution load to be calculated and are connected to the data processing device in a communication way, the sampler comprises a sampling head, and the sampling head comprises an outer protective grid and an inner fine filter mesh, the sampler is connected to the water quality detection device in a piping connection way, the water quality detection device receives wastewater collected by the sampler through a piping for detecting water quality, a water quality detection result comprises pollutant concentrations, after the data processing device receives flow data sent by the flow meter and pollutant concentrations sent by the water quality detection device, the load calculation system calculates the runoff pollution load using the following formula:
$$M = {\int }_{0}^{T} {C}_{t} {Q}_{t} dt = {\sum }_{j = 1}^{n} {C}_{j} {Q}_{j} Δ t$$
wherein M represents a runoff pollution load after a single rainfall; Cₜ represents runoff pollutant concentrations of a rainfall at time t, measured in mg/L; Qₜ represents a runoff instantaneous flow of a rainfall at time t, measured in m³/s; Cⱼ represents runoff pollutant concentrations of a rainfall during a jth sampling, measured in mg/L; Qⱼ represents a runoff instantaneous flow of a rainfall during a jth sampling, measured in m³/s; Δt represents a time interval between two sampling, measured in min;
wherein the target region comprises a plurality of characteristic regions with different regional relevant characteristics, each of the plurality of characteristic regions comprises a plurality of sub-catchment regions, the target region comprises a plurality of outfalls, and each of the plurality of outfalls collects a plurality of runoff pollution loads from different sub-catchment regions;
a data obtaining module, configured to, for any sub-catchment region corresponding to the target outfall, obtain load characteristic factors corresponding to a current sub-catchment region and characteristic coefficients corresponding to the load characteristic factors when calculating a runoff pollution load based on the load characteristic factors, wherein the load characteristic factors are factors which affect the pollution load formed when runoff pollutants from each of the plurality of sub-catchment regions collects at a catchment outlet, and the characteristic coefficients are determined based on load characteristic factors corresponding to a plurality of preset sub-catchment regions within the target region and a runoff pollution load equivalent in a preset year;
a runoff pollution load determining module, configured to determine a runoff pollution load of the current sub-catchment region in the preset year based on the load characteristic factors and the characteristic coefficients; and
a target runoff pollution load determining module, configured to determine a sum of runoff pollution loads for each sub-catchment region corresponding to the target outfall in the preset year, and adjust the sum of runoff pollution loads based on a time correction factor between a target year and the preset year to determine a target runoff pollution load of the target outfall in the target year.

9. A terminal electronic device, wherein, the terminal electronic device comprises a processor and a memory connected to the processor in a communication way;
the memory has computer executable instructions stored thereon; and
the processor is configured to, when executing the computer executable instructions, implement the runoff pollution load calculation method according to claim 1.

10. A computer-readable storage medium, wherein the computer-readable storage medium has computer-executable instructions stored thereon, and the computer-executable instructions, when executed by the processor, are configured to implement the runoff pollution load calculation method according to claim 1.
